(19) United States
(12) Patent Application Publication
(10) Pub. No.: US 2012/0286909 A1
(43) Pub. Date: Nov. 15, 2012

(54) METHOD FOR PRODUCING DUST CORE, AND DUST CORE PRODUCED BY THE METHOD

(75) Inventors: Takeshi OHWAKI, Kobe-shi (JP); Hiroyuki Mitani, Kobe-shi (JP); Hirofumi Hojo, Takasago-shi (JP); Tomotsuna Kamijo, Takasago-shi (JP); Akihiko Tatsumi, Kobe-shi (JP); Wataru Urushihara, Kobe-shi (JP); Mikako Takeda, Kobe-shi (JP); Mamoru Hosokawa, Kobe-shi (JP)

(73) Assignee: Kabushiki Kaisha Kobe Seiko Sho (Kobe Steel, Ltd.), Kobe-shi (JP)

(21) Appl. No.: 13/435,757

(22) Filed: Mar. 30, 2012

(30) Foreign Application Priority Data
May 9, 2011 (JP) 2011-104582
Jan. 18, 2012 (JP) 2012-008450

(51) Int. Cl. H01F 3/08; B22F 3/20; B22F 3/12

(52) U.S. Cl. 335/297; 419/19

(57) ABSTRACT

A method produces a dust core by molding a mixture through compression molding to give a powder compact, the mixture containing an oxygen-source-releasable compound and an iron-based soft magnetic powder for powder compacts including an iron-based soft magnetic matrix powder and an insulating coating film present on the surface of the matrix powder; and heating the powder compact to oxidize at least the surface of the iron-based soft magnetic matrix powder by the action of the oxygen-source-releasable compound. The resulting dust core excels not only in mechanical strength but also in resistivity (insulation).

### FIELD OF INVENTION

The present invention relates to a method for producing a dust core, and a dust core produced by the method.

### BACKGROUND OF THE INVENTION

Dust cores for electromagnetic parts should have good handleability in production process and should have sufficient mechanical strength so as not to be broken upon coiling into coils. In consideration of these requirements, there is known in the area of dust cores a technique of covering iron powder particles with an electrically insulating material. By covering the iron powder particles with the electrically insulating material, the iron powder particles are bonded with one another by the medium of the electrically insulating material, and this gives a dust core having improved mechanical strength.

There have been disclosed techniques of using as the electrically insulating material, a silicone resin having good heat resistance or a vitrified (glassy) compound obtained typically from phosphoric acid (e.g., Japanese Patent No. 2710152).

The assignee of the present invention has successfully provided a dust core having a high magnetic flux density, a low core loss, and high mechanical strengths by forming a phosphate conversion coating film containing specific elements, and a silicon resin coating film in this order on a surface of an iron-based soft magnetic powder, and already has obtained a Japanese patent for this technique (Japanese Patent No. 4044591).

However, with an increasing demand for higher performance of dust cores as compared to those at the date of filing of Japanese Patent No. 4044591, dust cores having further satisfactory mechanical strengths are demanded.

### SUMMARY OF THE INVENTION

Under these circumstances, an object of the present invention is to provide a dust core having a further satisfactory mechanical strength.

Specifically, the present invention achieves the object and provides a method for producing a dust core. The method includes the steps of molding a mixture through compression molding to give a powder compact, the mixture containing an oxygen-source-releasable compound and an iron-based soft magnetic powder for powder compacts including an iron-based soft magnetic matrix powder and an insulating coating film present on the surface of the matrix powder, and heating the powder compact as a heat treatment to oxidize at least the surface of the iron-based soft magnetic matrix powder by the action of the oxygen-source-releasable compound.

Some preferred embodiments of the present invention are as follows. The oxygen-source-releasable compound is preferably at least one selected from the group consisting of sugar alcohols, metal hydroxides, metal peroxides, percarbonates, and oxidizers. The heat treatment step is preferably performed by heating the powder compact at 200° C. to 700° C. The method preferably further includes another heat treatment step of heating the powder compact at 200° C. to 500° C. before the heat treatment step at 200° C. to 700° C., wherein the heat treatment step at 200° C. to 700° C. is performed at a temperature higher than the temperature of the heat treatment step at 200° C. to 500° C. The mixture preferably further contains a lubricant. The lubricant is preferably a polyhydroxycarboxamide. The insulating coating film is preferably an inorganic conversion coating film and/or a resin coating film.

The present invention further includes a dust core produced by the method.

The production method according to the present invention provides a dust core having a further satisfactory mechanical strength.

### BRIEF DESCRIPTION OF DRAWINGS

FIG. 1 is a graph illustrating the bending strength of samples when heat-treated at 600° C. in a nitrogen atmosphere for 30 minutes in experimental examples mentioned below;

FIG. 2 is a graph illustrating the resistivity of samples when heat-treated at 600° C. in a nitrogen atmosphere for 30 minutes in the experimental examples;

FIG. 3 is a graph illustrating the bending strength of samples when heat-treated at 550° C. in an air atmosphere for 30 minutes in the experimental examples;

FIG. 4 is a graph illustrating the resistivity of samples when heat-treated at 550° C. in an air atmosphere for 30 minutes in the experimental examples;

FIG. 5 is a graph illustrating the bending strength of samples when heat-treated in two steps in the experimental examples; and

FIG. 6 is a graph illustrating the resistivity of samples when heat-treated in two steps in the experimental examples.

### DETAILED DESCRIPTION OF THE PREFERRED EMBODIMENTS

A production method according to an embodiment of the present invention includes the steps of molding a mixture through compression molding to give a powder compact (molding step), the mixture containing an oxygen-source-releasable compound and an iron-based soft magnetic powder for powder compacts (hereinafter also simply referred to as “iron powder for powder compacts”) including an iron-based soft magnetic matrix powder and an insulating coating film present on the surface of the matrix powder, and heating the powder compact (heat treatment step).

According to the present invention, a dust core having an improved mechanical strength is obtained. This is probably because the heat treatment step allows the oxygen-source-releasable compound to oxidize at least the surface of the iron-based soft magnetic powder, this helps the insulating coating film to form firm binding with the surface of the iron-based soft magnetic powder and to thereby improve the binding power among the iron-based soft magnetic powder particles. As a result, a dust core having a more satisfactory mechanical strength is obtained without significantly reduction in density. Although the resistivity decreases with an increasing mechanical strength in many cases, the method according to the present invention allows the resulting dust core to have further higher mechanical strength while maintaining or increasing its resistivity. The present invention will be illustrated in detail below.

Iron-Based Soft Magnetic Matrix Powder

The iron-based soft magnetic matrix powder for use in the present invention as a matrix powder is a ferromagnetic metal powder, which is exemplified by pure iron powders; iron-based alloy powders such as powders of Fe—Al alloys, Fe—Si alloys, sendust, and Permalloys; and amorphous powders. These soft magnetic matrix powders may be produced typically by atomizing molten iron (or molten iron-based alloy) into fine particles, followed by reduction and pulverization. This process gives soft magnetic matrix powders having a median particle size (D50) of about 20 to 250 μm such that a cumulative particle size distribution be 50% in a particle size distribution measured by sieve analysis. Among them, a soft magnetic matrix powder having an average particle size (median particle size) of about 50 to 150 μm is preferably used in the present invention.

Insulating Coating Film

The iron powder for powder compacts for use in the present invention includes an iron-based soft magnetic matrix powder and, arranged on the surface thereof, one or more insulating coating films. Exemplary insulating coating films include inorganic conversion coating films such as phosphate conversion coating films and chromate conversion coating films; and resin coating films such as silicone resin coating films, phenolic resin coating films, epoxy resin coating films, polyamide resin coating films, and polyimide resin coating films. Of inorganic conversion coating films, a phosphate conversion coating film is preferred; whereas, of resin coating films, a silicone resin coating film is preferred. The insulating coating film may be composed of any of the above-listed coating films alone or composed of a laminate of two or more of the coating films. Such phosphate conversion coating film and silicone resin coating film will be illustrated in detail below.

Phosphate Conversion Coating Film

The composition of the phosphate conversion coating film is not limited, as long as being a vitrified coating film formed from a compound containing phosphorus (P), but is preferably a vitrified coating film formed from a compound further containing cobalt (Co), sodium (Na), and sulfur (S) and/or further containing cesium (Cs) and/or aluminum (Al), in addition to P. These elements inhibit oxygen from forming a semiconductor with iron (Fe) and from thereby lowering the resistivity upon heat treatment step.

When the phosphate conversion coating film is a vitrified coating film formed from a compound containing the above-specified element(s) such as Co in addition to P, the contents of these elements are preferably such that the P content is from 0.005 percent by mass to 1 percent by mass, the Co content is from 0.005 percent by mass to 0.1 percent by mass, the Na content is from 0.002 percent by mass to 0.6 percent by mass, and the S content is from 0.001 percent by mass to 0.2 percent by mass; as well as the Cs content is from 0.002 percent by mass to 0.6 percent by mass, and the Al content is from 0.001 percent by mass to 0.1 percent by mass, based on the total amount (100 percent by mass) of the iron powder for powder compacts (the total mass of the iron-based soft magnetic matrix powder and the phosphate conversion coating film). When Cs and Al are used in combination, it is preferred that the contents of these elements fall within the above-specified ranges, respectively.

Of the elements, phosphorus (P) forms a chemical binding with the surface of the iron-based soft magnetic matrix powder with the medium of oxygen. For this reason, if the P content is less than 0.005 percent by mass, the chemical binding between the surface of the iron-based soft magnetic matrix powder and the phosphate conversion coating film may be insufficient in amount, and this may impede the formation of a firm coating film. In contrast, if the P content exceeds 1 percent by mass, phosphorus, which is not involved in chemical binding, remains as unreacted, and this may contrarily lower the binding strength.

The elements Co, Na, S, Cs, and Al each have the function of inhibiting the formation of a semiconductor between Fe and oxygen upon the heat treatment step and thereby suppressing reduction in resistivity. The effects of Co, Na, and S are maximized when they are added in combination. Either one of Cs and Al may be added alone. The lower limits of the contents of respective elements are determined as minimum contents so as to exhibit the effects of the combination addition of Co, Na, and S. Co, Na, S, Cs, and Al, if added in excessively high contents more than necessary, not only fail to maintain good relative balance among them when added in combination, but also probably impede the formation of chemical binding between P and the surface of the iron-based soft magnetic matrix powder through the medium of oxygen.

The phosphate conversion coating film may further contain magnesium (Mg) and/or boron (B). These elements, when contained, are preferably present in contents of from 0.001 percent by mass to 0.5 percent by mass, respectively, based on the total amount (100 percent by mass) of the iron powder for powder compacts.

The phosphate conversion coating film preferably has a thickness of from about 1 nm to about 250 nm. The phosphate conversion coating film, if having a thickness of less than 1 nm, may not exhibit sufficient insulating effects. In contrast, the phosphate conversion coating film, if having a thickness of more than 250 nm, may have saturated insulating effects and may be not desirable for a higher density of the resulting powder compact. The thickness is more preferably from 10 nm to 50 nm.

Process for Formation of Phosphate Conversion Coating Film

The iron powder for powder compacts for use herein may be produced in any form. Typically, the iron powder may be produced by mixing a solution of a phosphorus-containing compound and an iron-based soft magnetic matrix powder with a solvent composed of water and/or an organic solvent; and evaporating the solvent according to necessity.

Exemplary solvents for use in this step include water, hydrophilic organic solvents such as alcohols and ketones; and mixtures of them. The solvent may further contain a known surfactant.

Examples of the phosphorus-containing compound include orthophosphoric acid (H₃PO₄). Exemplary compounds to give a phosphate conversion coating film having the above-specified composition include Co₃(PO₄)₂ (Co and P source), Co₃(PO₄)₂.8H₂O (Co and P source), Na₂HPO₄ (P and Na source), NaH₂PO₄.nH₂O (P and Na source), Al (H₂PO₄)₃(P and Al source), Cs₂SO₄ (Cs and S source), H₂SO₄ (S source), MgO (Mg source), and H₃BO₃ (B source). Among them, sodium dihydrogenphosphate (Na₂HPO₄), when used as P source and Na source, can give a dust core having a density, a strength, and a resistivity in good balance.

The amount of the phosphorus-containing compound to be added to the iron-based soft magnetic matrix powder may be such that the resulting phosphate conversion coating film has a composition falling within the above-specified range. The phosphate conversion coating film can have a composition falling within the above-specified range, for example, by adding a solution of such a phosphorus-containing compound and, where necessary, a compound containing element(s) to be contained in the coating film in an amount of from about 1 to about 10 parts by mass to 100 parts by mass of the iron-based soft magnetic matrix powder, and mixing them with a known mixing machine such as mixer, ball mill, kneader, V-blender, or granulator. The solution has been prepared so as to have a solid content of from about 0.01 percent by mass to about 10 percent by mass.

Where necessary, the process may further include the step of drying at 150° C. to 250° C. in air under reduced pressure or under a vacuum, after the mixing step. After drying, the resulting article may be sieved through a screen having an opening of from about 200 μm to about 500 μm. Through the step(s), an iron powder for powder compacts bearing a phosphate conversion coating film formed thereon is obtained.

Silicone Resin Coating Film

The iron powder for powder compacts according to the present invention may further include a silicone resin coating film on the phosphate conversion coating film. This configuration helps powder particles to be bonded with one another firmly upon completion of crosslinking/curing reaction (compression) of the silicone resin and forms Si—O binding which excels in heat resistance to thereby improve the thermal stability of the insulating coating film.

A silicone resin which is cured slowly may give a sticky powder and may thereby give a coating film with poor handleability. To avoid this, the silicone resin for use herein is more preferably one having a trifunctional unit (T unit) (RSiX₃ where X is a hydrolyzable group) than one having a bifunctional unit (D unit) (R₂SiX₂ where X is as defined above). It should be noted that a silicone resin, if containing a large amount of a quadrifunctional (tetrafunctional) unit (Q unit) (SiX₄ where X is as defined above), may cause excessively firm binding among powder particles upon precuring, and this may impede the subsequent molding step. For these reasons, the silicone resin has T units in an amount of preferably 60 percent by mole or more, more preferably 80 percent by mole or more, and most preferably 100 percent by mole.

Methylphenylsilicone resins, where R is methyl group or phenyl group, have been generally used as such silicone resins, and it has been believed that a methylphenylsilicone resin containing phenyl group in a larger amount has better heat resistance. However, the present inventors have found that the presence of phenyl group is not so effective under such high-temperature heat treatment conditions as employed in the present invention. This is probably because the bulkiness of phenyl group disturbs the dense vitrified network structure and thereby contrarily lowers the thermal stability and the inhibition effect on formation of a compound with iron. Accordingly, in a preferred embodiment, the present invention employs a methylphenylsilicone resin having methyl group in a content of 50 percent by mole or more (e.g., the trade name KR255 or KR311 supplied by Shin-Etsu Chemical Co. Ltd), more preferably a methylphenylsilicone resin having methyl group in a content of 70 percent by mole or more (e.g., the trade name KR300 supplied by Shin-Etsu Chemical Co. Ltd.), and most preferably a methylsilicone resin having no phenyl group (e.g., the trade name KR251, KR400, KR220L, KR242A, KR240, KR500, or KC89 each supplied by Shin-Etsu Chemical Co. Ltd.; or the trade name SR2400 supplied by Dow Corning Toray Co., Ltd.). The ratio between methyl group and phenyl group and the functionality of the silicone resin (coating film) may be analyzed typically through Fourier transform infrared spectroscopy (FT-IR).

The mass of coating of the silicone resin coating film is preferably regulated to be from 0.05 percent by mass to 0.3 percent by mass based on the total amount (100 percent by mass) of the iron powder for powder compacts bearing the phosphate conversion coating film and the silicone resin coating film formed in this order. If the silicone resin coating film is present in a mass of coating of less than 0.05 percent by mass, the resulting iron powder for powder compacts may have insufficient insulating properties and have a low electric resistance. In contrast, the silicone resin coating film, if present in a mass of coating of more than 0.3 percent by mass, may impede the resulting powder compact in having a high density.

The silicone resin coating film has a thickness of preferably from 1 nm to 200 nm, and more preferably from 20 nm to 150 nm. The total thickness of the phosphate conversion coating film and the silicone resin coating film is preferably 250 nm or less. If the total thickness exceeds 250 nm, the dust core may have an insufficient magnetic flux density.

Process for Formation of Silicone Resin Coating Film

The silicone resin coating film may be formed, for example, by mixing a silicone resin solution with an iron-based soft magnetic matrix powder bearing a phosphate conversion coating film (hereinafter also simply referred to as “phosphate-conversion-film-coated iron powder” for the sake of convenience), in which the solution is a solution of a silicone resin dissolved in an organic solvent including an alcohol or a petroleum organic solvent such as toluene or xylene; and evaporating the organic solvent according to necessity.

The silicone resin may be added to the phosphate-conversion-film-coated iron powder in such an amount that the mass of coating of the formed silicone resin coating film falls within the above-specified range. For example, a resin solution prepared so as to have a solid content of from about 2 percent by mass to about 10 percent by mass may be added in an amount of from about 0.5 percent by mass to about 10 percent by mass to 100 percent by mass of the phosphate-conversion-film-coated iron powder, followed by drying. The resin solution, if added in an amount of less than 0.5 percent by mass, it may take a long time for mixing or the resulting coating film may become non-uniform. In contrast, the resin solution, if added in an amount of more than 10 percent by mass, may cause an excessively long time for drying or may cause insufficient drying. The resin solution may have been as appropriate before mixing. The mixer for use herein may be the same as mentioned above.

The drying step is preferably performed so that the organic solvent evaporates and volatilizes sufficiently by heating the work at a temperature which allows the organic solvent to volatilize and which is lower than the curing temperature of the silicone resin. Specifically, when the organic solvent is any of the alcohols and petroleum organic solvents, the drying temperature is preferably from about 60° C. to about 80° C. After drying, the resulting powder particles are preferably sieved through a screen with an opening of from about 300 μm to about 500 μm to remove aggregated undissolved lumps.

After drying, the silicone resin coating film is preferably precured by heating the iron powder for powder compacts bearing the silicone resin coating film formed thereon (hereinafter also simply referred to as “silicone-resin-coated iron powder” for the sake of convenience). The precuring keeps the coated powder particles separate from one another upon curing of the silicone resin coating film. In other words, the precuring permits the silicone-resin-coated iron powder to flow upon warm molding (at about 100° C. to about 250° C.). Specifically, for the sake of simplicity, precuring may be performed by heating the silicone-resin-coated iron powder for a short time at a temperature near the curing temperature of the silicone resin. Precuring may also be performed with the help of an agent (curing agent). Difference between precuring and final curing (not precuring but complete curing) is that precuring does not completely bond powder particles together (to allow powder particles to be pulverized easily) and final curing (which is carried out at high temperatures after compaction) firmly bonds powder particles together. Thus, final curing gives a sufficiently strong powder compact.

Precuring and subsequent pulverization, as described above, yield an easily flowing powder that can be readily (like sand) fed into a mold upon compression molding. Without precuring, powder particles are so sticky to one another upon warm molding that it is difficult to feed them into a mold within a short time. Good handleability is essential in practical production process. It was found that precuring makes the dust core significantly increase in resistivity. This may probably be attributable to the iron powder particles (iron powder for powder compacts) becoming more compact as the result of final curing.

Precuring by heating for a short time may be accomplished by heating at 100° C. to 200° C. for 5 to 100 minutes, and preferably at 130° C. to 170° C. for 10 to 30 minutes. After precuring, the coated iron powder is preferably sieved in the same manner as mentioned above.

Oxygen-Source-Releasable Compound

The iron powder for powder compacts for use in the present invention contains an oxygen-source-releasable compound. The oxygen-source-releasable compound releases an oxygen source such as oxygen, water, or hydrogen peroxide to oxidize the surface of iron powder for powder compacts upon heating of the powder compact in the heat treatment step. In addition, as the oxygen-source-releasable compound is also present inside of the powder compact, the oxidation of the surface of the iron powder for powder compacts proceeds also in a core portion of the powder compact upon the heat treatment step. Specifically, the presence of the oxygen-source-releasable compound gives a powder compact having a volume fraction (average) of magnetite (Fe₃O₄) of 0.1% or more, and preferably 0.5% or more. The volume fraction is an average of measurements at arbitrary three points at a depth of 2 mm or more from the surface of the powder compact. The volume fraction of magnetite may be measured by X-ray diffractometry mentioned later.

The resulting dust core according to the present invention has firm binding between the surface of the iron-based soft magnetic matrix powder and the insulating coating film(s) (e.g., phosphate conversion coating film), has firm binding between the insulating coating films with each other, and thereby has a more satisfactory mechanical strength. The dust core also has a higher resistivity (better insulation).

To exhibit these effects effectively, the oxygen-source-releasable compound is preferably contained in a content of 0.01 percent by mass or more based on the total amount of the mixture of the iron powder for powder compacts, lubricant, and oxygen-source-releasable compound. However, the oxygen-source-releasable compound is preferably contained in a content of 0.8 percent by mass or less, because excess oxygen-source-releasable compound is adverse to increasing the density of the powder compact.

The oxygen-source-releasable compound is not limited, as long as capable of releasing an oxygen source such as oxygen, water, and/or hydrogen peroxide through heating. Examples thereof include sugar alcohols which release water through heating, such as erythritol, glycerol, isomalt, lactitol, maltitol, mannitol, sorbitol, and xylitol; metal hydroxides which release water through heating, such as magnesium hydroxide, aluminum hydroxide, calcium hydroxide, manganese hydroxide, iron hydroxide, cobalt hydroxide, nickel hydroxide, and copper hydroxide; metal peroxides which release oxygen through heating, such as lithium peroxide, sodium peroxide, and zinc peroxide; percarbonates which release hydrogen peroxide that decomposes into water and oxygen through heating, such as sodium percarbonate; and oxidizers such as nitrate anion, nitrite anion, and chlorate anion Exemplary counter ions (cations) for oxidizers include lithium ion, sodium ion, potassium ion, ammonium ion, calcium ion, strontium ion, and barium ion Each of different oxygen-source-releasable compounds may be used alone or in combination.

Lubricant

The iron powder for powder compacts for use herein preferably further contains a lubricant. The lubricant reduces friction among iron powder particles or allows iron powder particles to flow smoothly along the mold's inner wall upon compression molding. Reduced friction protects the mold from damage by the powder compact and suppresses heat generation upon molding. The amount of lubricant for the desired effect is 0.2 percent by mass or more based on the total amount of the mixture including the iron powder for powder compacts, lubricant, and oxygen-source-releasable compound, but is preferably 0.8 percent by mass or less, because excess lubricant is adverse to increasing the density of the powder compact. An amount less than 0.2 percent by mass will be enough if a lubricant is applied to the inner wall of the mold for compression molding (die wall lubrication molding).

Any known lubricant can be used, which is exemplified by metal salt powders of stearic acid, such as zinc stearate, lithium stearate, and calcium stearate; polyhydroxycarboxamides; fatty acid amides such as ethylenebisstearamide and (N-octadecenyl)hexadecanamide; paraffins; waxes; and natural or synthetic resin derivatives. Among them, polyhydroxycarboxamides and fatty acid amides are preferred. Each of different lubricants may be used alone or in combination.

Exemplary polyhydroxycarboxamides include those represented by the formula: CₘHₘ₊₁(OH)ₘ—CONH—CₙH₂ₙ₊₁ where m is 2 or 5; and n is an integer of from 6 to 24, as described in PCT International Publication Number WO2005/068588.

More specific examples include the following polyhydroxycarboxamides:

(1) n-C₂H₃(OH)₂—CONH-n-C₆H₁₃: (N-Hexyl)glyceramide

(2) n-C₂H₃(OH)₂—CONH-n-C₈H₁₇: (N-Octyl)glyceramide

(3) n-C₂H₃(OH)₂—CONH-n-C₁₈H₃₇: (N-Octadecyl)glyceramide

(4) n-C₂H₃(OH)₂—CONH-n-C₁₈H₃₅: (N-Octadecenyl)glyceramide

(5) n-C₂H₃(OH)₂—CONH-n-C: (N-Docosyl)glyceramide

(6) n-C₂H₃(OH)₂—CONH-n-C₂₄H₄₉: (N-Tetracosyl)glyceramide

(7) n-C₅H₆(OH)₅—CONH-n-C₆H₁₃: (N-Hexyl)gluconamide

(8) n-C₅H₆(OH)₅—CONH-n-C₈H₁₇: (N-Octyl)gluconamide

(9) n-C₅H₆(OH)₅—CONH-n-C₁₈H₃₇: (N-Octadecyl)gluconamide

(10) n-C₅H₆(OH)₅—CONH-n-C₁₈H₃₅: (N-Octadecenyl)gluconamide

(11) n-C₅H₆(OH)₅—CONH-n-C₂₂—H₄₅: (N-Docosyl)gluconamide

(12) n-C₅H₆(OH)₅—CONH-n-C₂₄H₄₉: (N-Tetracosyl)gluconamide

Compression Molding

The powder compact is obtained by subjecting a mixture to compression molding, which mixture contains the iron powder for powder compacts (which may include a silicone resin coating film), the oxygen-source-releasable compound, and, where necessary, the lubricant. The compression molding may be performed by any known procedure.

The compression molding is preferably performed at a surface pressure of from 490 MPa to 1960 MPa. The molding may be performed as either room-temperature molding or warm molding (at 100° C. to 250° C.). The compression molding is preferably performed as warm molding through die wall lubrication molding so as to give a dust core having a higher strength.

Heat Treatment Step

According to the present invention, the powder compact after compression molding is annealed at a high temperature (preferably from 200° C. to 700° C.) (this step is hereinafter also referred to as “heat treatment step 2”). This step not only reduces hysteresis loss of the dust core but also oxidizes at least the surface of the iron-based soft magnetic powder by the action of an oxygen source released from the oxygen-source-releasable compound. The annealing in this step is performed at a temperature of preferably 200° C. or higher, more preferably 300° C. or higher, and furthermore preferably 500° C. or higher. The heat treatment step 2 is preferably performed at a higher temperature unless the resistivity is lowered. The annealing temperature is preferably 700° C. or lower, and more preferably 650° C. or lower. Annealing at a temperature higher than 700° C. may damage the insulating coating film.

To perform oxidation by the oxygen-source-releasable compound furthermore effectively, the method according to the present invention preferably includes a heat treatment step 1 prior to the heat treatment step 2. In the heat treatment step 1, the powder compact is heat-treated at 200° C. to 500° C. Heating of the powder compact at a relatively low temperature of from 200° C. to 500° C. allows the oxygen-source-releasable compound to release an organic source, such as oxygen, water, and/or hydrogen peroxide, gradually. Such gradual release of the oxygen source suppresses clogging of the feed pathway of the oxygen source over a long time, which feed pathway is present among iron powder particles in the powder compact. This allows oxidation of a larger amount of iron powder particles. In addition, upon treatment in the heat treatment step 2, not only the oxygen source inside the powder compact but also the oxygen source, which is released from the oxygen-source-releasable compound and present in the atmosphere (and oxygen contained in the atmosphere in advance) contribute to the oxidation of iron powder particles. This efficiently accelerates the oxidation of the inside of the powder compact to give a dust core having higher mechanical strengths (particularly bending strength).

Even when the powder compact includes a lubricant, the heating treatment in the heat treatment step 1 at a temperature within the above-specified range enables efficient vaporization and scattering of the lubricant while inhibiting the lubricant from dogging the feed pathway for the oxygen source present among iron powder particles. Accordingly, the aforementioned oxidation acceleration effect can be obtained in the subsequent heat treatment step 2.

The heat treatment step 1, if performed at an excessively high temperature, may cause the oxygen-source-releasable compound to release the oxygen source rapidly in an excessively short time. As a result, the heat treatment step 1 may fail to sufficiently effectively suppress dogging by the lubricant and may fail to allow the lubricant to evaporate and scatter sufficiently. In addition, the heat treatment step 2 may invite insufficient oxygen source in the inside of the powder compact to thereby cause insufficient oxidation of the powder compact inside thereof. To avoid these, heating in the heat treatment step 1 is performed at a temperature of preferably 500° C. or lower, and more preferably 450° C. or lower. In contrast, the heating, if performed at an excessively low temperature, may cause insufficient release of the oxygen source or may impede efficient evaporation and scattering of the lubricant. To avoid these, heating in the heat treatment step 1 is performed at a temperature of preferably 200° C. or higher and more preferably 250° C. or higher.

The atmosphere(s) in the heat treatment step 1 and the heat treatment step 2 is not limited and may be an air atmosphere or an inert gas atmosphere. Exemplary inert gases include nitrogen; and rare gases such as helium and argon. The atmosphere may also be a vacuum atmosphere. Among these atmospheres, air atmosphere is preferred. Heat treatment in an air atmosphere significantly increases the resistivity. Annealing time in each heat treatment step is not limited, as long as not adversely affecting the resistivity, but is preferably 10 minutes or longer, and more preferably 20 minutes or longer, because an excessively short heating (annealing) may not provide the desired effects sufficiently. In contrast, the annealing time is preferably 360 minutes or shorter, and more preferably 300 minutes or shorter, because an excessively long heating may thin the insulating coating film and may thereby cause insufficient insulation.

When both the heat treatment step 1 and the heat treatment step 2 are performed, the heat treatment step 2 is preferably performed at a temperature higher than that of the heat treatment step 1 and is more preferably performed at a temperature of higher than 500° C. and 700° C. or lower. Such two-step heat treatments performed separately reduce the hysteresis loss of the dust core and give significantly effective oxidation acceleration.

After the heat treatment step 1, the heat treatment step 2 may be performed without cooling or after cooling. For example, when the heat treatment step 2 is performed in another atmosphere in the vessel than that in the heat treatment step 1, the heat treatment step 2 may be performed by cooling the work after the completion of the heat treatment step 1, regulating or changing the atmosphere, and then rising the temperature to a predetermined level. When an identical atmosphere is employed in both steps, the work after the heat treatment step 1 is raised in temperature to a predetermined level, followed by the heat treatment step 2.

The average rate of temperature rise (or average cooling rate) in the heat treatment steps is not critical and may be typically from about 0.5° C. per minute to about 50° C. per minute.

The heat treatment steps under the aforementioned conditions can produce a dust core having a high electrical insulating properties, namely, high resistivity can be produced without increasing eddy current loss (corresponding to coercive force).

Dust Core

The dust core according to the present invention can be obtained by cooling the work to mom temperature after the heat treatment step(s).

### EXAMPLES

The present invention will be illustrated in further detail with reference to several experimental examples below. It should be noted, however, that the examples are never construed to limit the scope of the present invention and may be modified or changed without departing from the scope and sprit of the present invention. All parts and percentages are by mass, unless otherwise specified.

### Experimental Examples 1 to 13

### Molding Step

The experiment was performed with a pure iron powder as the soft magnetic powder and a treating composition for phosphate conversion coating film. The iron powder is “ATOMEL (registered trademark) 300NH” supplied by Kabushiki Kaisha Kobe Seiko Sho (Kobe Steel, Ltd.); having an average particle diameter of 80 to 100 μm). The treating composition is one prepared by mixing 50 parts of water, 30 parts of NaH₂PO₄, 10 parts of H₃PO₄, 10 parts of (NH₂OH)₂.H₂SO₄, and 10 parts of Co₃(PO₄)₂ and diluting with water ten times to have a phosphoric acid concentration of 1.5%.

The treating composition (50 ml) was added to 1 kg of the pure iron powder (which had been sieved through a screen having an opening of 300 μm), mixed in a V-blender for 30 minutes or longer, dried at 200° C. in the air atmosphere for 30 minutes, sieved through a screen having an opening of 300 μm, and thereby yielded an iron powder bearing a phosphate conversion coating film in a thickness of 20 nm.

Next, a silicone resin having methyl groups in a content of 100 percent by mole and including T-units in a content of 100 percent by mole (“KR220L” supplied by Shin-Etsu Chemical Co. Ltd.) was dissolved in toluene and thereby yielded a resin solution having a solids content of 4.8%. The resin solution was added to and mixed with the iron powder (bearing the phosphate conversion coating film) so that the mass of coating of the silicone resin coating film be 0.05 percent by mass based on the total amount (100 percent by mass) of the resulting iron powder for powder compacts bearing the phosphate conversion coating film and the silicone resin coating film. The work was heated and thereby dried in an oven furnace at 75° C. in the air atmosphere for 30 minutes and sieved through a screen having an opening of 300 μm. The sieved particles were subjected to precuring at 150° C. for 30 minutes and thereby yielded an iron powder for powder compacts bearing the silicone resin coating film in a thickness of 100 nm.

Next, a polyhydroxycarboxamide as the lubricant was added to and mixed with the iron powder so as to be in an amount of 0.2 percent by mass based on the total amount of the iron powder for powder compacts, the lubricant, and the oxygen-source-releasable compound. In some experimental examples, an oxygen-source-releasable compound was further added in an amount of 0.1 percent by mass based on the total amount of the mixture of the iron powder for powder compacts, the lubricant, and the oxygen-source-releasable compound. The oxygen-source-releasable compound was one of mannitol as the sugar alcohol, aluminum hydroxide as the metal hydroxide, lithium peroxide as the metal peroxide, sodium percarbonate as the percarbonate, and potassium nitrate as the oxidizer, as indicated in tables below. The resulting mixture was placed in a mold, subjected to compression molding at a surface pressure of 784 MPa at room temperature (25° C.) and thereby yielded powder compacts measuring 31.75 mm in length, 12.7 mm in width, and about 5 mm in height.

Heat Treatment Steps

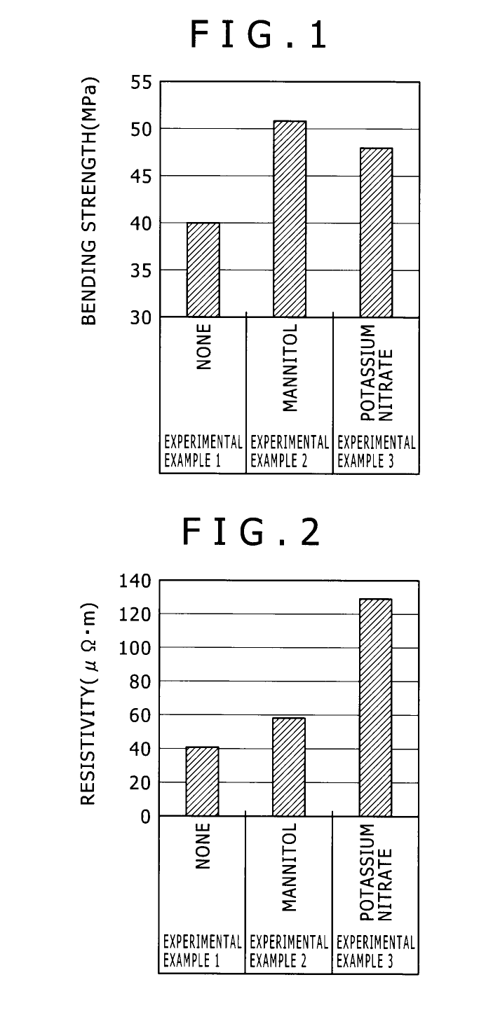

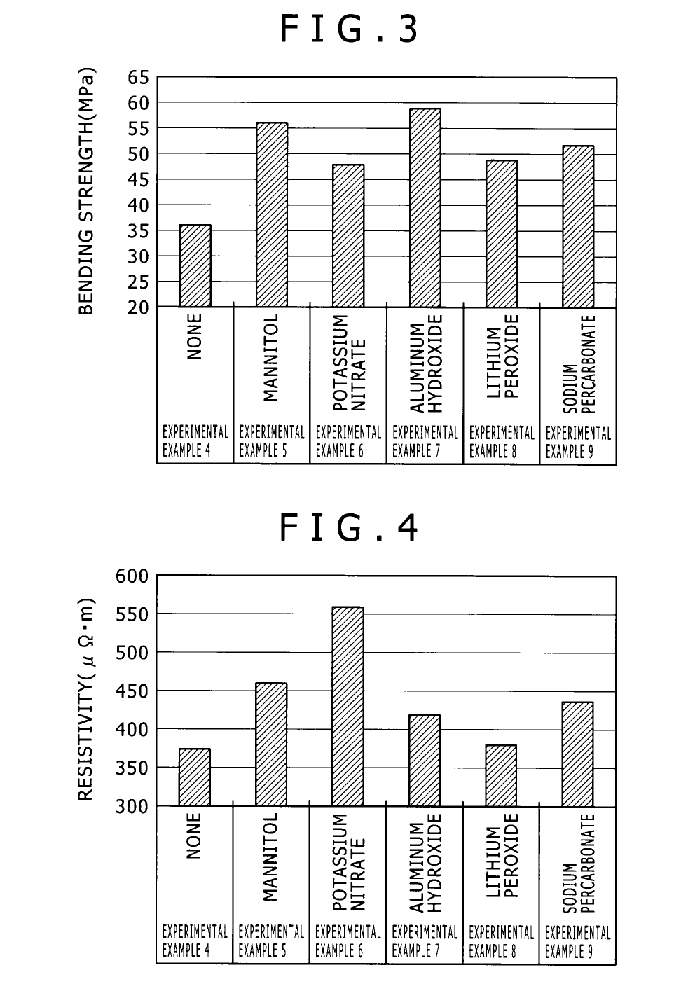

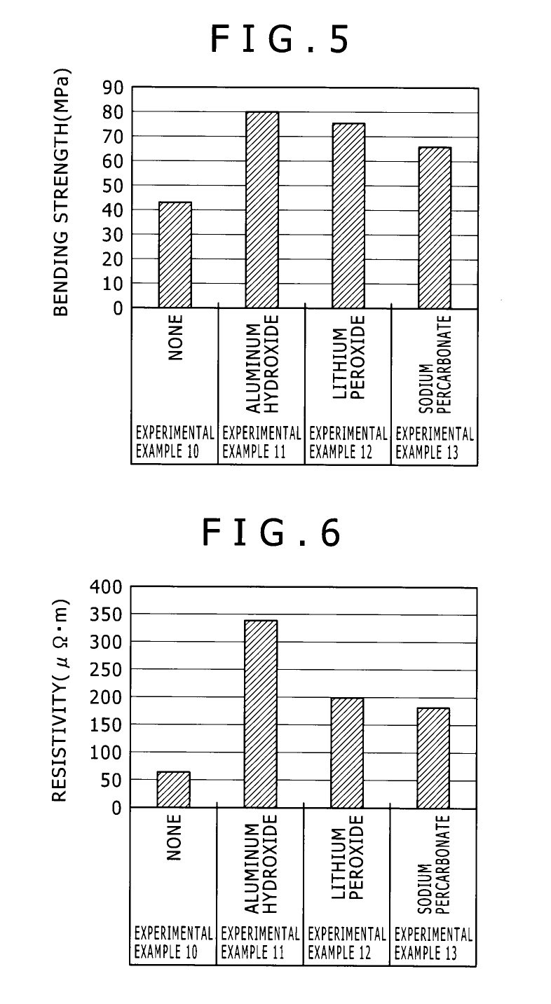

The powder compacts were subjected to (A) a heat treatment at 600° C. in a nitrogen atmosphere for 30 minutes (Table 1, FIG. 1, and FIG. 2); or (B) a heat treatment at 550° C. in the air atmosphere for 30 minutes (Table 2, FIG. 3, and FIG. 4); or (C) a heat treatment step 1 at 300° C. or 400° C. in the air atmosphere for 120 minutes and subsequently a heat treatment step 2 at 550° C. for 30 minutes (Table 3, FIG. 5, and FIG. 6), and thereby yielded dust cores. The rate of temperature rise herein is about 10° C. per minute.

The resulting dust cores after the heat treatment were examined for density, resistivity, bending strength, and volume fraction of magnetite (Fe₃O₄), according to the following methods.

Density

The density was determined by actually measuring the mass and size of a sample dust core, and calculating the density from the measured data.

Resistivity

The resistivity was measured with the “RM-14L” supplied by Rika Denshi Co., Ltd as a probe and the digital multimeter “VOAC-7510” supplied by IWATSU ELECTRIC CO., LTD. as a measuring instrument according to a four-probe resistance measurement mode (four probe method). The measurement was performed at a probe-to-probe distance of 7 mm and a probe stroke length of 5.9 mm, under a spring load of 10-S type with the probes being pressed onto the measurement specimen.

Bending Strength

The mechanical strength of the dust core was measured in terms of bending strength. The bending strength was measured by performing a bending strength test of a specimen plate-like dust core, as a three-point bending test according to JPMA M 09-1992 (method for bending strength test of sintered metal materials) of the Japan Powder Metallurgy Association, with the tensile tester “AUTOGRAPH AG-5000E” (supplied by Shimadzu Corporation) at a chuck-to-chuck distance of 25 mm.

Volume Fraction of Magnetite (Fe₃O₄)

The volume fraction of magnetite contained in the dust core was measured on the specimen after the bending strength test. Specifically, X-ray diffractometry was performed by applying X-rays to the surface which had been broken and exposed as a result of the bending strength test, and thereby the volume fraction of magnetite was measured with the two-dimensional X-ray diffractometer “RINT-RAPID II” (suitable for microanalysis) supplied by Rigaku Corporation. The measurement was performed using Kα line with a Co target and a monochromator at a measurement angle (20) of from 30 degrees to 110 degrees. X rays were applied in an area of about 0.6 mm in diameter in the measurement surface. The fracture surface is a rectangular area of 12.7 mm in breadth and about 5 mm in height, at arbitrary three points (Regions 1 to 3) at the central part of the fracture surface, specifically, 2 mm or more inside (downward) from the top and 2 mm or more inside (upward) from the bottom. Peak fitting was performed on the area of peak derived from Fe₃O₄ and on the area of peak derived from Fe to determine volume fractions of magnetite (Fe₃O₄) and average thereof.

TABLE 1

| | Oxygen-source- | Heat | | | Bending | | | | |
|---|---|---|---|---|---|---|---|---|---|
| Experimental | releasable | treatment | Density | Resistivity | strength | Volume fraction of Fe₃O₄(%) | | | |
| Examples | compound | condition A | (g/cm³) | (μΩ · m) | (MPa) | Region 1 | Region 2 | Region 3 | Average |
| No. 1 | None | at 600° C. in | 7.42 | 41 | 40 | 0.0 | 0.0 | 0.0 | 0.0 |
| No. 2 | Mannitol | nitrogen for | 7.39 | 58 | 51 | 1.0 | 0.9 | 0.7 | 0.87 |
| No. 3 | Potassium nitrate | 30 min. | 7.40 | 129 | 48 | 0.7 | 1.0 | 0.6 | 0.77 |

TABLE 2

| | Oxygen-source- | Heat | | | Bending | | | | |
|---|---|---|---|---|---|---|---|---|---|
| Experimental | releasable | treatment | Density | Resistivity | strength | Volume fraction of Fe₃O₄(%) | | | |
| Examples | compound | condition B | (g/cm³) | (μΩ · m) | (MPa) | Region 1 | Region 2 | Region 3 | Average |
| No. 4 | None | at 550° C. in | 7.42 | 374 | 36 | 0.0 | 0.0 | 0.0 | 0.0 |
| No. 5 | Mannitol | air for 30 min. | 7.40 | 460 | 56 | 1.1 | 0.8 | 0.9 | 0.93 |
| No. 6 | Potassium nitrate | | 7.41 | 561 | 48 | 0.7 | 0.6 | 0.8 | 0.70 |
| No. 7 | Aluminum hydroxide | | 7.41 | 420 | 59 | 0.8 | 0.9 | 1.0 | 0.90 |
| No. 8 | Lithium peroxide | | 7.40 | 380 | 49 | 1.0 | 1.0 | 1.1 | 1.0 |
| No. 9 | Sodium percarbonate | | 7.39 | 438 | 52 | 0.9 | 1.1 | 1.2 | 1.1 |

TABLE 3

| | Oxygen-source- | | | | Bending | | | | |
|---|---|---|---|---|---|---|---|---|---|
| Experimental | releasable | | Density | Resistivity | strength | Volume fraction of Fe₃O₄(%) | | | |
| Examples | compound | Heat treatment condition C | (g/cm³) | (μΩ · m) | (MPa) | Region 1 | Region 2 | Region 3 | Average |
| No. 10 | None | at 400° C. in air for | 7.41 | 61 | 43 | 0.0 | 0.0 | 0.0 | 0.0 |
| No. 11 | Aluminum | 120 min. then at 550° C. | 7.39 | 336 | 80 | 1.8 | 2.0 | 2.1 | 2.0 |
| | hydroxide | in air for 30 min. | | | | | | | |
| No. 12 | Lithium peroxide | | 7.38 | 197 | 76 | 1.7 | 1.9 | 2.0 | 1.9 |
| No. 13 | Sodium | at 300° C. in air for | 7.37 | 178 | 66 | 1.8 | 1.9 | 2.1 | 1.9 |
| | percarbonate | 120 min. then at 550° C. | | | | | | | |
| | | in air for 30 min. | | | | | | | |

Table 1 and FIGS. 1 and 2 demonstrate that dust cores (Experimental Examples Nos. 2 and 3) produced by using an oxygen-source-releasable compound such as a sugar alcohol (mannitol) or an oxidizer (potassium nitrate) excel in resistivity and mechanical strength (bending strength) while maintaining a satisfactory density, as compared to a dust core (Experimental Example No. 1) using no oxygen-source-releasable compound

Table 2 and FIGS. 3 and 4 demonstrate that dust cores (Experimental Examples Nos. 5 to 9) produced by using an oxygen-source-releasable compound excel in resistivity and mechanical strength (bending strength) while maintaining a satisfactory density or while not significantly decreasing in resistivity, as compared to a dust core (Experimental Example No. 4) using no oxygen-source-releasable compound.

Table 3 and FIGS. 5 and 6 demonstrate that dust cores (Experimental Examples Nos. 11 to 13) produced by using an oxygen-source-releasable compound excel in resistivity and mechanical strength (bending strength) while maintaining a satisfactory density, as compared to a dust core (Experimental Example No. 10) using no oxygen-source-releasable compound.

The data also demonstrate that dust cores undergone heat treatment(s) in an air atmosphere (heat treatment conditions B and C) are superior in resistivity to dust cores undergone heat treatment in a nitrogen atmosphere (heat treatment condition A).

In addition, the data demonstrate that dust cores undergone heat treatments in two steps (heat treatment condition C) are superior in mechanical strength (bending strength) to dust cores undergone heat treatment in one step (heat treatment conditions A and B).

The production method according to the present invention is advantageous in production of dust cores each having a thickness of 4 mm or more and of dust cores having a portion at a distance of 2 mm or more from the outermost surface.

The method according to the present invention can produce dust cores excellent in mechanical strengths. The dust cores are useful as cores for rotors and stators of motors.

What is claimed is:

1. A method for producing a dust core, the method comprising the steps of:
molding a mixture through compression molding to give a powder compact, the mixture containing an oxygen-source-releasable compound and an iron-based soft magnetic powder for powder compacts including an iron-based soft magnetic matrix powder and an insulating coating film present on the surface of the matrix powder, and
heating the powder compact as a heat treatment to oxidize at least the surface of the iron-based soft magnetic matrix powder by the action of the oxygen-source-releasable compound.

2. The method according to claim 1, wherein the oxygen-source-releasable compound is at least one selected from the group consisting of sugar alcohols, metal hydroxides, metal peroxides, percarbonates, and oxidizers.

3. The method according to one of claims 1 and 2, wherein the heat treatment step is performed by heating the powder compact at 200° C. to 700° C.

4. The method according to claim 3, further comprising another heat treatment step of heating the powder compact at 200° C. to 500° C. before the heat treatment step at 200° C. to 700° C., wherein the heat treatment step at 200° C. to 700° C. is performed at a temperature higher than the temperature of the heat treatment step at 200° C. to 500° C.

5. The method according to any one of claims 1 to 4, wherein the mixture further contains a lubricant.

6. The method according to claim 5, wherein the lubricant is a polyhydroxycarboxamide.

7. The method according to any one of claims 1 to 6, wherein the insulating coating film is an inorganic conversion coating film and/or a resin coating film.

8. A dust core produced by the method of any one of claims 1 to 7.
